(19) United States
(12) Patent Application Publication
(10) Pub. No.: US 2026/0007129 A1
(43) Pub. Date: Jan. 8, 2026

(54) FLEXIBLE ANTIMICROBIAL GLASS CAPABLE OF EFFECTIVELY INHIBITING REDUCTION OF SILVER IONS

(71) Applicants: CNBM RESEARCH INSTITUTE FOR ADVANCED GLASS MATERIALS GROUP CO., LTD., Bengbu (CN); China National Building Material Group Co., Ltd., Beijing (CN); Triumph Science & Technology Group Co. Ltd., Beijing (CN)

(72) Inventors: Shou PENG, Bengbu (CN); Chong ZHANG, Bengbu (CN); Chuanli SHAN, Bengbu (CN); Xin CAO, Bengbu (CN); Zhenkun KE, Bengbu (CN); Jiedong CUI, Bengbu (CN); Lifen SHI, Bengbu (CN); Zhaojin ZHONG, Bengbu (CN); Qiang GAO, Bengbu (CN); Pingping WANG, Bengbu (CN); Fengyang ZHAO, Bengbu (CN); Weiwei WANG, Bengbu (CN); Jinwei LI, Bengbu (CN); Jia NI, Bengbu (CN); Na HAN, Bengbu (CN); Wentao HU, Bengbu (CN); Changqing LI, Bengbu (CN); Yong YANG, Bengbu (CN); Gang ZHOU, Bengbu (CN); Peng WANG, Bengbu (CN); Xiaoyu ZHANG, Bengbu (CN)

(73) Assignees: CNBM RESEARCH INSTITUTE FOR ADVANCED GLASS MATERIALS GROUP CO., LTD., Bengbu (CN); China National Building Material Group Co., Ltd., Beijing (CN); Triumph Science & Technology Group Co. Ltd., Beijing (CN)

(21) Appl. No.: 18/880,256

(22) PCT Filed: Aug. 11, 2023
(86) PCT No.: PCT/CN2023/112613

§ 371 Date: Dec. 30, 2024

(30) Foreign Application Priority Data
Dec. 26, 2022 (CN) 2022116772213

(51) Int. Cl. A01N 25/08; A01N 59/16; A01P 1/00

(52) U.S. Cl. CPC A01N 25/08; A01N 59/16; A01P 1/00

(57) ABSTRACT

A flexible antimicrobial glass capable of effectively inhibiting the reduction of silver ions includes the following components in percentages by mass: 55-65% of SiO₂, 16-25% of Al₂O₃, 5-12% of Na₂O, 0.5-4% of K₂O, 2-8% of MgO, 0-1% of CaO, 0-2% of ZiO₂, 0.1-1% of Ag₂O, 0.2-3.55% of CoO, and 0-0.5% of Na₂S. The above constituting raw materials compose a batch, and the batch is melted and molded. The flexible antimicrobial glass can perfectly inhibit the reduction of silver ions into elemental silver, such that the yellowing of the glass is effectively controlled; it has antimicrobial performance, and the strength and toughness of the glass are prevented from damage because the flexible glass is thin. The glass has an antimicrobial activity grade of grade II, with the antimicrobial R being greater than or equal to 3, and has visible light transmittance at 380-780 nm of greater than or equal to 91%.

### TECHNICAL FIELD

The present application relates to a flexible antimicrobial glass, in particular, to a flexible antimicrobial glass capable of effectively inhibiting the reduction of silver ions.

### BACKGROUND

Bacteria and molds, as pathogenic bacteria, do great harm to human beings, animals, and plants. Therefore, people pay more and more attention to commodities with microbicidal and antimicrobial effects.

An electronic glass, as the key substrate of display products, is becoming larger and thinner with the rapid development of display industry, with a plate width undergone the generational transformation from 5G to 11G, and a thickness developed from 0.7 mm to 0.4 mm, even to 0.2 mm. A flexible glass with a thickness less than or equal to 0.1 mm has emerged under this background. With the arrival of the era of “internet plus”, the relationship between people's lives and hand-held electronic equipment is getting closer and closer, and the application of the flexible glass is becoming more and more extensive. When people touch screens, sweat and grease will attach to the screens, providing favorable conditions for the reproduction of bacteria and viruses, affecting people's health and even endangering their lives. Therefore, people pay more and more attention to flexible antimicrobial glass with microbicidal and antimicrobial effects.

Currently, the mainstream flexible antimicrobial glass product on the market is silver-loaded flexible glass. However, due to the very active chemical properties of silver, it is easy to undergo redox within the glass to form silver atoms, and the silver atoms will agglomerate with silver ions additionally to form silver particle agglomerates (such as Ag²⁺-Ag⁰⁺Ag⁺, Ag²⁺-Ag⁺+Ag⁺, etc.). When the sizes of silver particle agglomerates increase, the flexible glass will be colored and yellowed, and the transmittance of the silver-loaded flexible glass will also decrease accordingly, thus reducing the antimicrobial performance of the flexible antimicrobial glass. The conventional solution is to add Na₂S, Al₂O₃ and the like to make the silver ions form stable structures with them, such as Ag[AlO₄], [Ag(S₂O₃)₂]³⁻, so that the silver ions can exist stably. However, the structural stability of this complex is weak, which makes the effect of inhibiting the reduction of silver ions worse.

### SUMMARY OF THE INVENTION

The present application provides a flexible antimicrobial glass capable of effectively inhibiting the reduction of silver ions.

The technical solution provided by the present application is as follows:

The flexible antimicrobial glass capable of effectively inhibiting reduction of silver ions includes the following components in percentages by mass: 55-65% of SiO₂, 16-25% of Al₂O₃, 5-12% of Na₂O, 0.5-4% of K₂O, 2-8% of MgO, 0-1% of CaO, 0-2% of ZrO₂, 0.5-2% of Ag₂O, 0.41-3.55% of CoO, and 0-0.5% of Na₂S.

In the above technical solution, preferably, for the components of the glass, the raw material of the Na₂O is Na₂CO₃, the raw material of the K₂O is K₂CO₃, the raw material of the CaO is CaCO₃, the raw material of the Ag₂O is AgNO₃, and the raw material of the CoO is Co(NO₃)₂.6H₂O.

In the above technical solution, preferably, the SiO₂ has a particle size of 50-300 um, the Al₂O₃, MgO and ZrO have a particle size of 20-100 μm, the Na₂CO₃, K₂CO₃ and CaCO₃ have a particle size of 20-200 μm, and the AgNO₃ and Co(NO₃)₂.6H₂O have a particle size of 40-60 μm.

In the above technical solution, preferably, the glass including the above components in percentages by mass has a melting temperature of 1550° C.-1700° C.

In the above technical solution, preferably, the flexible antimicrobial glass has a transmittance at a visible light band of 380-780 nm (with a thickness of 30 μm-70 μm) of greater than or equal to 91%.

In the above technical solution, preferably, the flexible antimicrobial glass has an antimicrobial activity grade of grade II, with an antimicrobial R being greater than or equal to 3.

In the present application, a small amount (0.41-1.55%) of cobalt nitrate hexahydrate (Co(NO₃)₂.6H₂O) is added into the flexible glass formulation, so that cobalt nitrate hexahydrate and silver oxide form a silver-cobalt alloy in the glass melting process, and the chemical stability of the silver-cobalt alloy is excellent, which makes it difficult for silver ions to be reduced into elemental silver. In the formulation, cobalt can be used together with alumina, Na₂S and the like, which reduces the addition of cobalt while improving the effect of inhibiting the reduction of silver ions.

### DETAILED DESCRIPTION

The technical solution of the present application is further described below through specific examples. These examples are only used to illustrate the present application and are not used to limit the scope of the present application.

### EXAMPLE 1

A flexible antimicrobial glass capable of effectively inhibiting reduction of silver ions includes the following components in percentages by mass: 55-65% of SiO₂, 16-25% of Al₂O₃, 5-12% of Na₂O, 0.5-4% of K₂O, 2-8% of MgO, 0-1% of CaO, 0-2% of ZrO₂, 0.5-2% of Ag₂O, 0.41-3.55% of CoO, and 0-0.5% of Na₂S.

During the preparation of the flexible antimicrobial glass above, the raw material of Na₂O is Na₂CO₃, the raw material of K₂O is K₂CO₃, the raw material of CaO is CaCO₃, the raw material of Ag₂O is AgNO₃, and the raw material of CoO is Co(NO₃)₂.6H₂O. A constituting batch is calculated based on the components of the flexible antimicrobial glass in percentages by mass above, wherein the raw materials are composed in the following proportions: 55-65% of SiO₂, 16-25% of Al₂O₃, 8.5-20.5% of Na₂CO₃, 0.7-5.9% of K₂CO₃, 2-8% of MgO, 0-1.8% of CaO, 0-2% of ZrO₂, 0.7-2.9% of AgNO₃, 1.59-13.70% of Co(NO₃)₂.6H₂O, and 0-0.5% of Na₂S.

The SiO₂ has a particle size of 50-300 μm, the Al₂O₃, MgO and ZrO have a particle size of 20-100 μm, the Na₂CO₃, K₂CO₃ and CaCO₃ have a particle size of 20-200 μm, and the AgNO₃ and Co(NO₃)₂.6H₂O have a particle size of 40-60 μm.

The batch is melted to a temperature of 1550° C.-1700° C.; after that, the flexible antimicrobial glass made by a molding preparation process has a transmittance at a visible light band of 380-780 nm (with a thickness of 30 μm-70 μm) of greater than or equal to 91%.

The resulting flexible antimicrobial glass has an antimicrobial activity grade of grade II, with an antimicrobial R being greater than or equal to 3.

### Examples 1-6

| | Usage (wt. %) | | | | | |
|---|---|---|---|---|---|---|
| | Examples | | | | | |
| Components of raw materials | Example 1 | Example 2 | Example 3 | Example 4 | Example 5 | Example 6 |
| SiO₂ | 63 | 63.5 | 64 | 63.4 | 63.8 | 64.2 |
| Al₂O₃ | 19.5 | 19.5 | 19.5 | 19.5 | 19.5 | 19.5 |
| Na₂O | 9.7 | 9.7 | 9.7 | 9.7 | 9.7 | 9.7 |
| K₂O | 0.6 | 0.6 | 0.6 | 0.6 | 0.6 | 0.6 |
| MgO | 4.1 | 4.1 | 4.1 | 4.1 | 4.1 | 4.1 |
| CaO | 0.6 | 0.6 | 0.6 | 0.6 | 0.6 | 0.6 |
| ZrO₂ | 0.5 | 0.5 | 0.5 | 0.5 | 0.5 | 0.5 |
| Ag₂O | 0.5 | 0.5 | 0.5 | 0.5 | 0.5 | 0.5 |
| CoO | 1.5 | 1 | 0.5 | 1 | 0.5 | 0 |
| Na₂S | 0 | 0 | 0 | 0.1 | 0.2 | 0.3 |
| Average transmittance at 380- | 92.7 | 91.8 | 90.8 | 92.5 | 91.1 | 89.3 |
| 780 nm (thickness 30 μm) | | | | | | |
| Antimicrobial activity grade | Grade II | Grade II | Grade I | Grade II | Grade II | Grade I |

The effect of not adding CoO can be seen from Example 6. The effect of inhibiting the reduction of silver ions can be seen from the visible light transmittance. Because the glass develops color after the reduction of silver ions, the visible light transmittance is significantly reduced, and the visible light transmittance in Example 6 is only 89.3%.

1. A flexible antimicrobial glass capable of effectively inhibiting reduction of silver ions, comprising the following components in percentages by mass: 55-65% of SiO₂, 16-25% of Al₂O₃, 5-12% of Na₂O, 0.5-4% of K₂O, 2-8% of MgO, 0-1% of CaO, 0-2% of ZrO₂, 0.5-2% of Ag₂O, 0.41-3.55% of CoO, and 0-0.5% of Na₂S.

2. The flexible antimicrobial glass capable of effectively inhibiting the reduction of silver ions according to claim 1, wherein for the components of the glass, a raw material of the Na₂O is Na₂CO₃, a raw material of the K₂O is K₂CO₃, a raw material of the CaO is CaCO₃, a raw material of the Ag₂O is AgNO₃, and a raw material of the CoO is Co(NO₃)₂.6H₂O.

3. The flexible antimicrobial glass capable of effectively inhibiting the reduction of silver ions according to claim 1, wherein the SiO₂ has a particle size of 50-300 μm, the Al₂O₃, MgO and ZrO have a particle size of 20-100 μm, the Na₂CO₃, K₂CO₃ and CaCO₃ have a particle size of 20-200 μm, and the AgNO₃ and Co(NO₃)₂.6H₂O have a particle size of 40-60 μm.

4. The flexible antimicrobial glass capable of effectively inhibiting the reduction of silver ions according to claim 1, wherein the glass including said components in percentages by mass has a melting temperature of 1550° C.-1700° C.

5. The flexible antimicrobial glass capable of effectively inhibiting the reduction of silver ions according to claim 4, wherein the flexible antimicrobial glass has a thickness of 30 μm-70 μm and a transmittance at a visible light band of 380-780 nm of greater than or equal to 91%.

6. The flexible antimicrobial glass capable of effectively inhibiting the reduction of silver ions according to claim 1, wherein the flexible antimicrobial glass has an antimicrobial activity grade of grade II, with an antimicrobial R being greater than or equal to 3.
